(19) United States
(12) Patent Application Publication
(10) Pub. No.: US 2007/0050837 A1
(43) Pub. Date: Mar. 1, 2007

(54) Method, apparatus and system for generating and distributing rich digital bookmarks for digital content navigation

(76) Inventor: Alex A. Lopez-Estrada, Chandler, AZ (US)

Correspondence Address: INTEL CORPORATION;C/O INTELLEVATE, LLC, P.O. BOX 52050, MINNEAPOLIS, MN, 55402, US

(21) Appl. No.: 11/211,284

(22) Filed: Aug. 25, 2005

(51) Int. Cl. H04N 7/16; H04N 7/173

(52) U.S. Cl. 725/138; 725/136; 725/115

(57) ABSTRACT

A method, apparatus and system provide a user with rich digital bookmarks to navigate digital content. According to an embodiment of the invention, rich digital bookmarks may be generated for digital content and provided to a user for use to perform sophisticated trick mode actions in a user friendly manner.

### BACKGROUND

Use of digital media is becoming increasingly common. In home networks, for example, devices are increasingly able to handle digital content. As a result, usage models available to home network users are becoming more sophisticated and these users are demanding more powerful capabilities to share digital content throughout the house. Ease of use is still, however, imperative to users in this home network environment.

One critical feature for any usage model in a home network environment is the ability to manipulate media content. One type of media manipulation, typically known as “trick mode”, includes the ability to manipulate content with actions such as fast forward, fast reverse, time seek, jumping to a scene in a movie, etc., in addition to normal playback. VHS and DVD users who have become used to these features expect to have some, if not all, of this functionality available to them in other usage models.

Although it is currently possible for users to seek through digital content and perform basic trick play such as fast forward and/or fast rewind, these features are far from advanced and not very user friendly. Thus, for example, a user may have difficulty seeking a particular location in a movie without having a time reference. In other words, although the user may be able to rewind back to “Hour 1, Min 4” of a movie to watch a particular scene, the user has to know that the scene of interest is at “Hour 1, Min 4” of the content. If there user merely knows that he or she would like to go back to “the exciting car chase scene”, however, there is no existing means by which a user can do so without doing a “blind seek” (i.e., blindly rewinding through the content). Most existing digital media schemes do not provide any audio/video reference points.

### BRIEF DESCRIPTION OF THE DRAWINGS

The present invention is illustrated by way of example and not limitation in the figures of the accompanying drawings in which like references indicate similar elements, and in which:

FIG. 1 illustrates a typical home network scheme according to UPnP terminology;

FIG. 2 illustrates an embodiment of the present invention in further detail;

FIG. 3 illustrates the sequence of events according to one embodiment of the present invention;

FIG. 4 illustrates an example of a user interface on CP 210 using RDBs; and

FIG. 5 is a flowchart illustrating an embodiment of the present invention;

### DETAILED DESCRIPTION

Embodiments of the present invention provide a method, apparatus and system for generating and distributing rich digital bookmarks for digital media content navigation. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

DVD technology currently includes the concept of “chapter navigation” or “scene selection” which provides users with a visual time reference to search from and/or to jump to at any time during a movie. In the scenario described in the background, for example, a DVD user looking for “the exciting car chase scene” may view the scene selection menu to determine which point of the movie to rewind to in order to view the scene again. This user friendly scheme for allowing users to navigate through DVD content is a key aspect of manipulating content on DVDs. Having been exposed to, and having become familiar with, such a scheme, users today typically expect a user friendly viewing experience, in addition to the ability to perform trick mode functions.

Unfortunately, in contrast to the DVD scheme, other digital consumer content is not currently encoded with any chapter and/or scene navigation schemes. As a result, although users may use the limited trick mode capabilities available to digital content today to blindly seek a desired scene, these primitive capabilities may be frustrating to novice and sophisticated users alike. This frustration may be compounded by other factors such as streaming digital content. “Movies on demand” are a typical example of streaming digital content. Although seeming to providing viewers with a similar experience to a DVD experience, movies on demand viewers are in fact currently subject to a sub-par viewing experience. As described above, since the digital content is not encoded with any navigation scheme, users are forced to do a “blind seek” of the content they are interested in. The scenario is additionally complicated by the fact that the digital content may reside remotely, as a stand alone item on a server on a network and may be streamed to a consumer upon demand. As a result, the “blind seek” operations described above may have significantly slower responses than DVD responses because the media stream may have to be re-transported from the source (i.e., server) on every seek operation.

Many working groups and standards committee have been established to address these ease of use and interoperability issues. Standards such as “UPnP” (Universal Plug and Play), Intel Corporation's “NMPR” (“Networked Media Product Requirements”, most recently Version 2.1, 2005), and more recently, the “DLNA” (“Digital Living Network Alliance”, most recently Version 1.0, 2005) are each attempting to anticipate common usage models in the digital home and define protocols and guidelines to enable interoperability and ease of use within these models. Each standard addresses a different aspect of these issues.

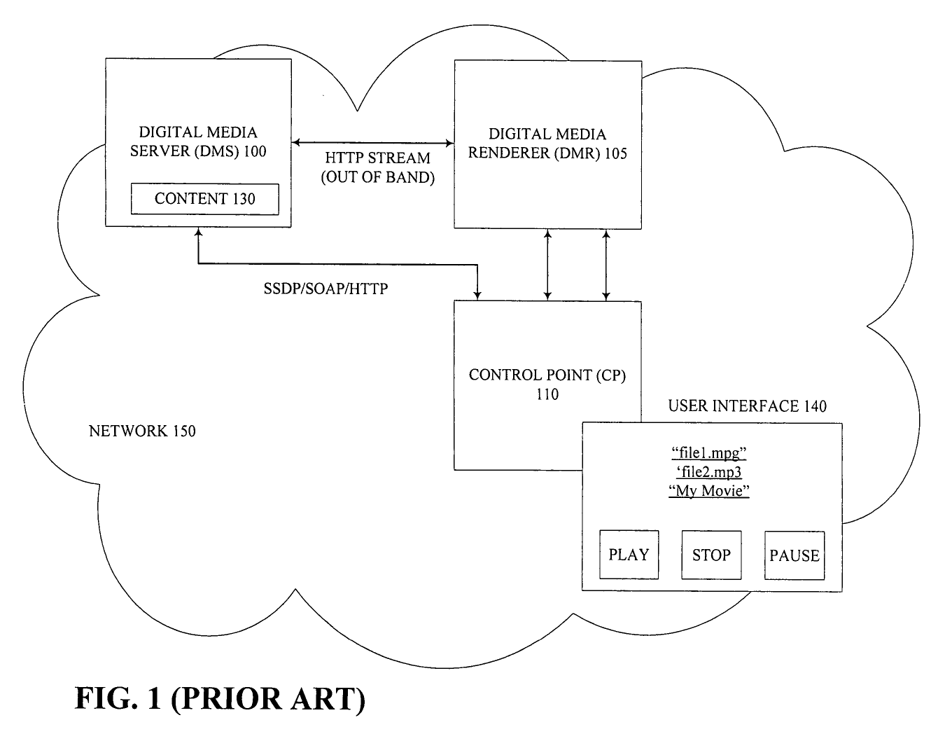

UPnP, for example, deals with the communication aspects of the devices by defining standard services and associated actions that a certain device needs to implement in order to be “seen” and “talk” to other devices. As illustrated in FIG. 1, using UPnP terminology, there are three typical devices in home network (“Network 150”): a Digital Media Server (“DMS 100”), a Digital Media Renderer (“DMR 105”) and a Control Point (“CP 110”). DMS 100 is the source of digital content (“Content 130”) while DMR 105 consumes Content 130. CP 110 discovers devices in the network, negotiates formats between DMS 100 and DMR 105 and establishes a connection between the devices. CP 110 additionally includes User Interface 140 which users may interact with to request Content 130. Discovery and negotiation may be performed using UPnP specified protocols (e.g., SSDP and SOAP), but once a connection is established, Content 130 may be streamed directly from DMS 100 to DMR 105 using out-of-band non-UPnP specific protocols such as Hyper Text Transport Protocol (“HTTP”). After the connection is established, the only intervention of CP 110 is for transport control including Play, Pause and Stop and Trick Mode actions, using standard defined SOAP actions. Device capabilities, such as what formats is able to handle is outside the scope of UPnP. There is no guarantee, therefore, that two UPnP devices will successfully interoperate.

DLNA, on the other hand, takes interoperability one step further and defines baseline capabilities that the devices need to support to be conformant. DLNA Version 1.0 deals with only two types of devices: the DMS and the Digital Media Player (DMP). In UPnP terms, a DMP comprises CP 110 coupled to DMR 105. The communication between DMR 105 and CP 110 is therefore not defined as they can live in the same box or as a single software process or piece of hardware. Future versions of DLNA may separate DMR 105 from CP 110, similar to the current UPnP scheme, or identify new types of devices.

An embodiment of the present invention provides a method, apparatus and system for generating and distributing rich digital bookmarks to enable users to easily manipulate digital content. The following description assumes the use of a UPnP scheme but embodiments of the present invention are not so limited. Thus, for example, alternate embodiments of the present invention may be implemented wherein CP 110 and DMR 105 are one process (e.g. a DMP in DLNA terms) and/or using non-UPnP protocols. Additionally, although the following description assumes audio/video content only, embodiments of the present invention are not so limited and may be applicable to any form and/or combination of digital content.

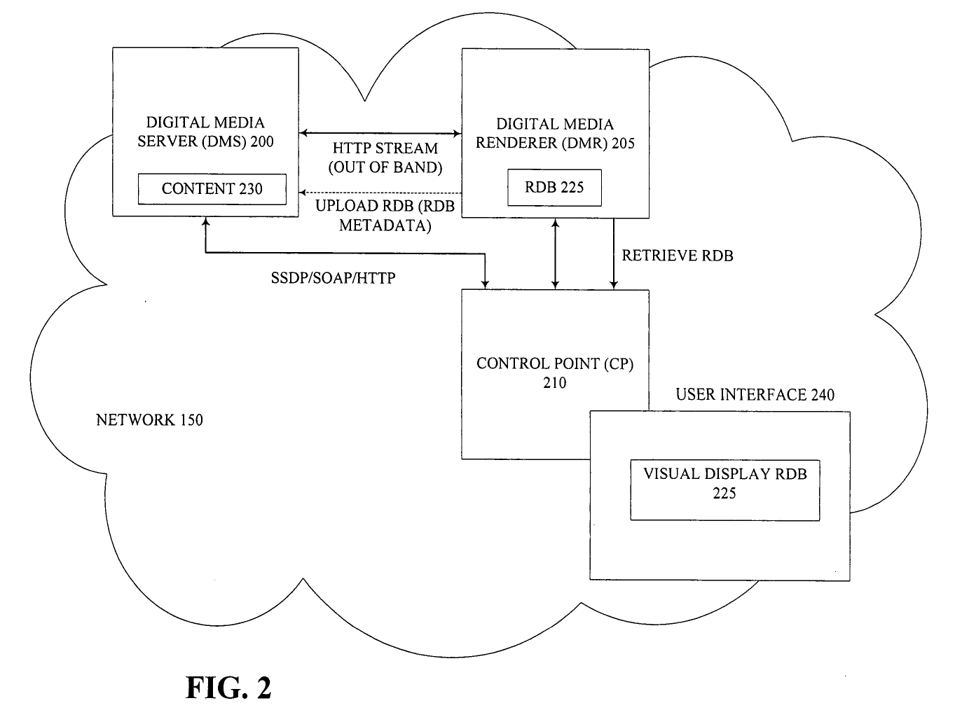

FIG. 2 illustrates an embodiment of the present invention. Specifically, in one embodiment, Rich Digital Bookmarks (illustrated collectively as “RDB 225”) for a specific content may be generated by DMR 205 that consumes a video stream (“Content 230”) from DMS 200 on Network 150. In alternate embodiments, RDB 225 may be generated by any device on Network 150 capable of interpreting video streams. For the purposes of simplifying the explanation, the following description assumes that RDB 225 is generated by DMR 105.

The term “digital bookmark” is well known to those of ordinary skill in the art and typically refers to any metadata associated with media content that may be used to randomly access a certain position within the content. According to embodiments of the present invention, RDB 225 comprises digital bookmarks that include additional information and/or data. Thus, for example, in one embodiment, RDB 225 includes (i) metadata to efficiently index to a position in the video content and (ii) items associated with the seek index in (i) that will serve as a “natural” easy to understand audio-visual reference to a human interacting with the device. Examples of metadata include a byte offset from the beginning of the movie, a time-stamp associated with RDB 225, frames into the movie, and/or any combination of these. Examples of items associated with the seek index include a text caption for RDB 225, a thumbnail or image frame associated with RDB 225, an audio fragment associated with RDB 225, and/or any combination of these.

RDB 225 may be generated in a variety of ways without departing from the spirit of embodiments of the present invention. Thus, for example, in one embodiment, RDB 225 may be generated in real-time while DMR 205 is processing (decoding) a video stream. Alternatively, RDB 225 may be generated “off-line” (i.e., in advance) upon user demand and/or upon demand from CP 210 during quiet or inactivity periods.

Regardless of how RDB 225 is generated, it may be accessed in a variety of ways without departing from the spirit of embodiments of the present invention. In one embodiment, RDB 225 may be retrieved (“pulled”) from DMR 205 at any time. The process of retrieving data from DMR 205 is well known to those of ordinary skill in the art and may include various standard actions and protocols currently known and/or hereafter determined. Alternatively, RDB 225 may be dynamically distributed (“pushed”) by DMR 205 (or any other device that generates RDB 225) to other devices on Network 250. Once accessed, RDB 225 may be displayed on User Interface 240, as illustrated (“VISUAL DISPLAY OF RDB 225”).

After RDB 225 is generated, it may be distributed by and/or be stored in various ways. In one embodiment, for example. RDB 225 may be multicast on Network 150 to any devices interested in the RDB. Alternatively, RDB 225 may be unicast to CP 210 and/or uploaded from CP 210 to DMS 200 as part of Content 230. DMS 200 may then provide RDB 225 to CP 210 for User Interface 240 and/or to DMR 205 for easy time-based accessing.

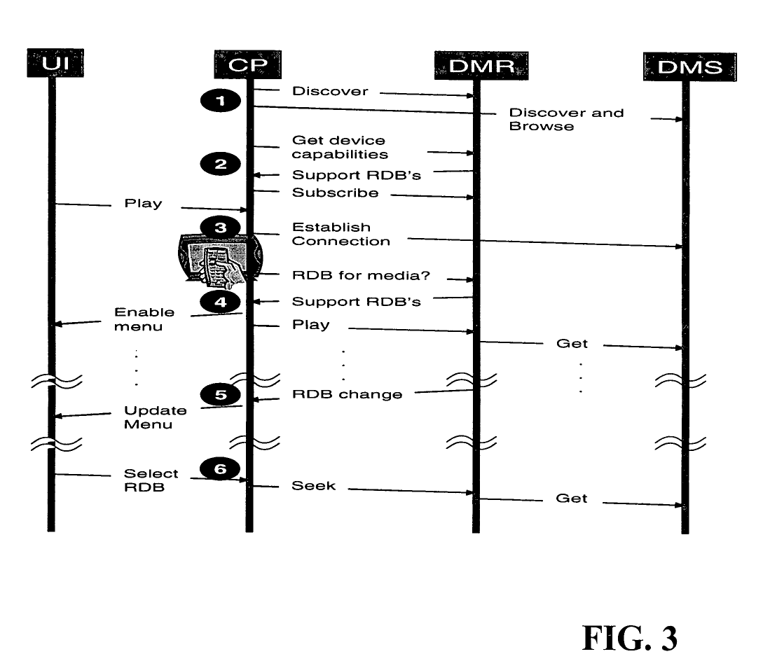

FIG. 3 illustrates the sequence of events according to one embodiment of the present invention. As illustrated, in 1, CP 210 may go through its typical discovery steps (discover DMR 205 as well as discover and browse the content on DMS 200). In one embodiment, DMR 205 may have decoding capabilities for a plurality of A/V streams, such as MPEG-2, H.264 and Windows Media. In 2, DMR 205 may assert to CP 210 that is capable of generating RDBs, and CP 210 may later utilize this information to enable/disable bookmark menus. More specifically, CP 210 may subscribe to the evented variable containing the state change for newly generated RDBs.

In 3, a user may (via a user interface on CP 210) elect to play Content 230 and when a connection is established to DMS 200 that contains the content, CP 210 may inquire whether DMR 200 is capable of generating RDBs for that specific content. In 4, if DMR 205 is capable of generating RDBs for Content 230 (information obtained in 2 above), CP 210 may enable a menu on the user interface (i.e., CP 210 may allow the user to navigate to a “Bookmarks” or “Scene Selection” type menu). DMR 205 may continuously retrieve Content 230 from DMS 200. As new RDB's are generated for the streaming content, DMR 205 may store locally some metadata that to enable mapping RDB 225 time-stamps to indices in the movie. In one embodiment, DMR 205 may then send an event to CP 210, describing the following RDB 225 metadata: RDB Time-Stamp, RDB Caption Text, RDB Thumbnail URI location for retrieval and RDB Audio Fragment URI location for retrieval. Additional description of the metadata is provided further below.

In 5, as new portions of Content 230 are retrieved from DMS 200, the RDBs associated with that portion of the content stream may be generated and these RDB changes may be updated on the previously enabled menu on the user interface. In 6, if the user (via the user interface on CP 210) selects an RDB, CP 210 may then perform a time-based seek transport action on DMR 205 using the time-stamp for the selected bookmark. DMR 205 may then proceed to map the time-stamp to the index data it has stored locally and seek to that position in the movie.

RDB 225 may be implemented in a variety of ways without departing from the spirit of embodiments of the present invention. In one embodiment, RDB 225 may be is implemented as a new UPnP variable. Thus, for example, the UPnP variable may be in the form of a Digital Item Declaration Language (“DIDL”) Lite Standard Markup Language (“XML”) associated with the resource. More specifically, a new state variable may be added to the UPnP audio visual Transport Service (called “CurrentTrackRDB” in this example). In one embodiment, this new state variable may be an evented variable and may also be accessed using a recommended new action (called “GetCurrentTrackRDB” in this example). In the context of the sequence diagram in FIG. 3, this new state variable may be used at 303, during RDB 225's change events, and the action GetCurrentTrackRDB may be used by CP 210 to retrieve the latest generated RDBs in 305.

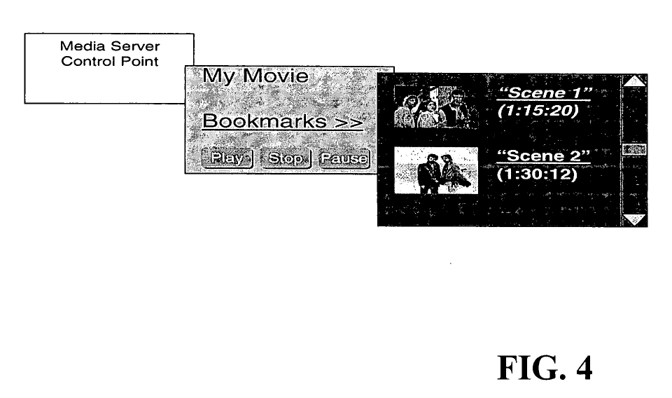

FIG. 4 illustrates an example of a user interface on CP 210 using RDBs. In one embodiment, as previously described above, each RDB entry may include one or more of a caption, a time stamp, a thumbnail Universal Resource Indicator (“URI”) and/or an audio fragment URI. Thus, for example, in one embodiment DMR 205 may send a generic caption, such as “Scene n”, where n is the RDB number (e.g., “Scene 3” corresponding to the third RDB). More sophisticated forms of captions may also be implemented (e.g., using speech recognition and speech to text algorithms to capture catch-phrases associated with an audio fragment close to the time stamp for RDB 225). In yet another embodiment, CP 210 may opt to use its own scheme for captions and ignore the ones provided by DMR 205 and/or DMS 200.

In various embodiments, the time intervals for RDB 225 may be device vendor configured and/or user configurable through the user interface on CP 210. Thus, for example, one potential configuration is an RDB every 5 minutes (300 seconds). In alternate embodiments, more sophisticated time intervals may be selected, such as video pattern recognition primitives to automatically identify interesting scene breakpoints.

In one embodiment, the stream splitters and/or decoders in DMR 205 may be responsible for identifying a picture frame in the encoded bit-stream that approximates the configured time interval. Thus, for example, in one embodiment, the source content may be in an MPEG format and/or another compression format that enables index frames. According to this scheme, reference frames such as MPEG “I-Frames” may be used for random access. I-frames are typically encoded every 0.5 seconds, thus offering a ½ second granularity in the selected RDB. DMR 205 may identify the I-frame that is closer to the specified time interval and store the file byte offset as a numeric integer, the actual time as a string “HH:MM:SS” and a frame position as a numeric integer number. In one embodiment, DMR 205 may then use the time-stamp as metadata to be sent to CP 210 as part of RDB 225's XML fragment.

In one embodiment, thumbnails may be generated by converting the closer I-frame identified during the time indexing step and encoding the I-frame as a JPEG image of small resolution, e.g. conformant to DLNA's “JPEG_TN” profile. The HTTP location of the image may also be added to the RDB metadata XML fragment. Additionally, in one embodiment, DMR 205 may retrieve the first n seconds (e.g., 5 seconds) of audio after the first sample exceeding a certain magnitude to avoid silent periods. DMR 205 may then decode the audio excerpt and encodes as an mp3 file conformant to DLNA's MP3 profile. In alternate embodiments, more sophisticated DMRs or devices may perform audio processing to identify the most interesting audio fragment within the bookmark interval.

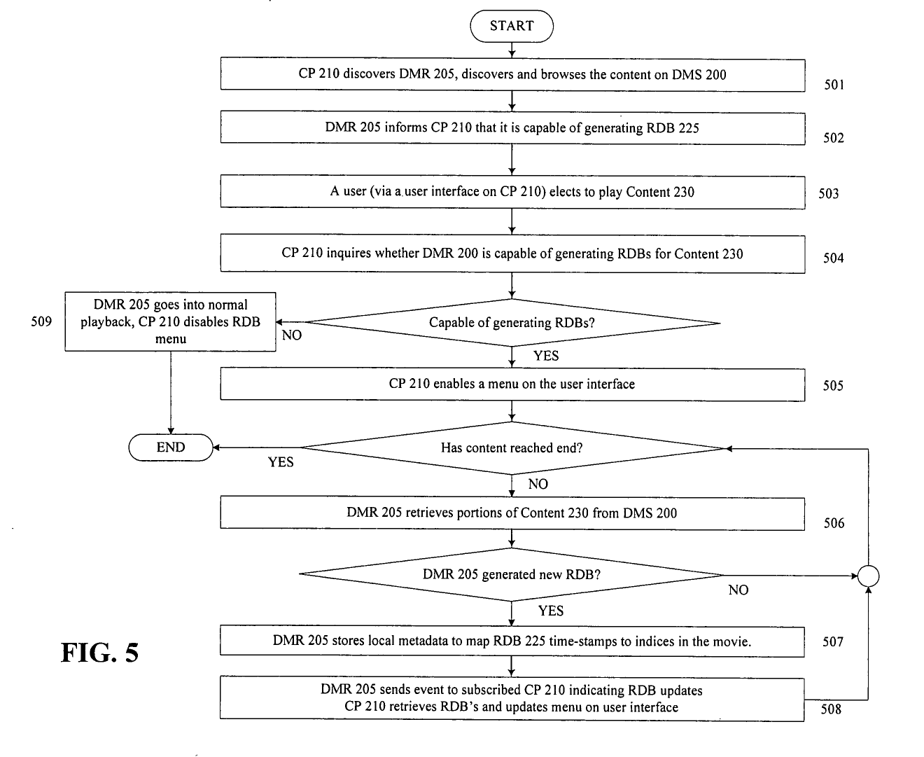

FIG. 5 is a flow chart illustrating an embodiment of the present invention in further detail. Although the following operations may be described as a sequential process, many of the operations may in fact be performed in parallel and/or concurrently. In addition, the order of the operations may be re-arranged without departing from the spirit of embodiments of the invention. In one embodiment of the present invention, in 501, CP 210 may discover DMR 205 as well as discover and browse the content on DMS 200. In 502, DMR 205 may inform CP 210 that it is capable of generating RDB 225. In 503, a user may (via a user interface on CP 210) elect to play Content 230 and in 504, when a connection is established to DMS 200 that contains the content, CP 210 may inquire whether DMR 200 is capable of generating RDBs for Content 230. In 505, if DMR 205 is capable of generating RDBs for Content 230 (information obtained in 302 above), CP 210 may enable a menu on the user interface (i.e., CP 210 may allow the user to navigate to a “Bookmarks” or “Scene Selection” type menu). DMR 205 may continuously retrieve content from DMS 200 in 506 and in 507, as new RDB's are generated for the streaming content, DMR 205 may store locally some metadata to enable mapping RDB 225 time-stamps to indices in the movie. In 508, DMR 205 may send an event to CP 210 to indicate that new RDBs have been generated, and in turn, CP 210 may retrieve the RDBs from DMR 205 to update its user interface menu. In 505, however, if DMR 205 is not capable of generating RDBs for Content 230, then DMR 205 may go back into a normal playback mode and CP 210 may disable the RDB menu.

Embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A system comprising:
a digital media server containing digital content capable of having associated rich digital bookmarks;
a digital media renderer capable of retrieving and streaming the digital content and rich digital bookmarks; and
a control point capable of enabling a user interface and presenting a menu of the rich digital bookmarks to enable users to navigate the digital content using the rich digital bookmarks.

2. The system according to claim 1 wherein the digital media server generates the rich digital bookmarks for the digital content.

3. The system according to claim 1 wherein the digital media renderer generates the rich digital bookmarks for the digital content.

4. The system according to claim 3 wherein the digital media renderer transmits the rich digital bookmarks for the digital content to the digital media server for storage with the digital media content.

5. The system according to claim 1 wherein each of the rich digital bookmarks represents a jump to a predetermined location in the digital media content.

6. The system according to claim 1 wherein the digital media comprises non-DVD digital media.

7. The system according to claim 1 wherein the rich digital bookmark comprises at least one of a time stamp, a thumbnail, an audio excerpt and a caption associated with the digital content.

8. The system according to claim 1 wherein the rich digital bookmarks are generated based on at least one of a predetermined video time interval, a predetermined video frame type, a predetermined audio time interval and a caption associated with the digital content.

9. The system according to claim 8 wherein the video frame type is an MPEG I-frame.

10. A method comprising:
retrieving digital content;
examining the digital content to determine whether the digital content includes rich digital bookmarks;
if the digital content includes rich digital bookmarks, accessing a menu to allow a user to navigate through the content using the rich digital bookmarks.

11. The method according to claim 10 further comprising:
if the digital content excludes rich digital bookmarks, generating rich digital bookmarks for the digital content.

12. The method according to claim 11 further comprising:
continuously generating rich digital bookmarks for the digital content as the digital content is streamed to the user.

13. The method according to claim 12 further comprising:
transmitting the rich digital bookmarks to be stored with the digital content.

14. The method according to claim 10 further comprising:
jumping to a predetermined location in the digital content upon the user's selection of one of the rich digital bookmarks.

15. A method comprising:
generating a plurality of rich digital bookmarks for non-DVD digital media.

16. The method according to claim 15 wherein generating the plurality of rich digital bookmarks occurs when the non-DVD digital media is accessed by a user.

17. The method according to claim 16 further comprising continuously generating additional rich digital bookmarks for the non-DVD digital media as the non-DVD digital media is streamed to the user.

18. The method according to claim 17 wherein generating the plurality of rich digital bookmarks for the non-DVD digital media further comprises generating the plurality of rich digital bookmarks prior to the non-DVD digital media being accessed by a user.

19. The method according to claim 17 further comprising:
storing the plurality of rich digital bookmarks and the additional rich digital bookmarks with the non-DVD digital media.

20. A method comprising:
generating a plurality of rich digital bookmarks for a digital content;
storing the plurality of rich digital bookmarks with the digital content;
accessing the rich digital bookmarks when the digital content is retrieved; and
transmitting the rich digital bookmarks and the digital content when requested by a user.

21. The method according to claim 20 wherein generating the plurality of rich digital bookmarks for the digital content occurs when the digital content is accessed by the user.

22. The method according to claim 20 wherein generating the plurality of rich digital bookmarks for the digital content occurs prior to the digital content being accessed by the user.

23. The method according to claim 20 wherein generating a plurality of rich digital bookmarks further comprises generating at least one of a time stamp, a thumbnail, an audio excerpt and a caption associated with the digital content.

24. The method according to claim 20 wherein generating a plurality of rich digital bookmarks for a digital content further comprises generating the plurality of rich digital bookmarks based on at least one of a predetermined video time interval, a predetermined video frame type, a predetermined audio time interval and a caption associated with the digital content

25. An article comprising a machine-accessible medium having stored thereon instructions that, when executed by a machine, cause the machine to:
retrieve digital content;
examine the digital content to determine whether the digital content includes rich digital bookmarks;
if the digital content includes rich digital bookmarks, access a menu to allow a user to navigate through the digital content using the rich digital bookmarks.

26. The article according to claim 25 wherein the instructions, when executed by the machine, further cause the machine to:
if the digital content excludes rich digital bookmarks, generate rich digital bookmarks for the digital content.

27. The article according to claim 26 wherein the instructions, when executed by the machine, further cause the machine to:
continuously generate rich digital bookmarks for the digital content as the digital content is streamed to the user.

28. The article according to claim 27 wherein the instructions, when executed by the machine, further cause the machine to:
transmit the rich digital bookmarks to be stored with the digital content.

29. The article according to claim 25 wherein the instructions, when executed by the machine, further cause the machine to:
jump to a predetermined location in the digital content upon the user's selection of one of the rich digital bookmarks.

30. An article comprising a machine-accessible medium having stored thereon instructions that, when executed by a machine, cause the machine to:
generate a plurality of rich digital bookmarks for a digital content;
store the plurality of rich digital bookmarks with the digital content;
access the rich digital bookmarks when the digital content is retrieved; and
transmit the rich digital bookmarks and the digital content when requested by a user.

31. The article according to claim 30 wherein the instructions, when executed by the machine, further cause the machine to generate the plurality of rich digital bookmarks for the digital content occurs when the digital content is accessed by the user.

32. The article according to claim 30 wherein the instructions, when executed by the machine, further cause the machine to generate the plurality of rich digital bookmarks for the digital content occurs prior to the digital content being accessed by the user.
